(19) United States
(12) Patent Application Publication
(10) Pub. No.: US 2012/0029092 A1
(43) Pub. Date: Feb. 2, 2012

(54) PRODUCT CONTAINING DIAMIDES, METHOD FOR MAKING SAME AND USES THEREOF

(75) Inventor: Massimo Guglieri, Monaco (MC)

(73) Assignee: RHODIA OPERATIONS, AUBERVILLIERS (FR)

(21) Appl. No.: 13/120,374

(22) PCT Filed: Sep. 21, 2009
(86) PCT No.: PCT/EP09/62208

§ 371 Date: Oct. 4, 2011

(30) Foreign Application Priority Data
Sep. 22, 2008 (FR) 0805188

(51) Int. Cl. A01N 25/02; C09K 3/00; C11D 7/60; C09D 7/12; C09D 11/00; C08K 5/20; A01P 1/00; C10M 133/16

(52) U.S. Cl. 514/788; 252/364; 252/182.12; 508/555; 106/505; 106/31.13; 524/227; 510/365; 510/501

(57) ABSTRACT

The product comprises at least two diamide compounds selected from the diamide compounds of following formulae (Ia), (Ib), and (Ic):

R²R³NOC-A^{a}-CONR⁴R⁵ (Ia)

R²R³NOC-A^{b}-CONR⁴R⁵ (Ib)

R²R³NOC-A^{c}-CONR⁴R⁵ (Ic)

wherein:
R², R³, R⁴, and R⁵, either identical or different, are groups selected from saturated or unsaturated, linear or branched, optionally cyclic, optionally aromatic, optionally substituted, hydrocarbon groups comprising an average number of carbon atoms ranging from 1 to 36, R² and R³ on the one hand and R⁴ and R⁵ on the other hand may optionally form together a ring, optionally substituted and/or optionally comprising a heteroatom, and
A^{a}, A^{b}, and A^{c} are linear divalent alkyl groups, each comprising a different number of carbon atoms.

The present invention relates to novel products comprising diamide compounds, to uses of the products and to at least one preparation method. These products may notably be used as solvents, for example in phytosanitary formulations.

Industry uses many chemicals as solvents, for example for preparing chemical products and materials for formulating chemical compounds or for treating surfaces. For example, solvents are used for the formulation of phytosanitary actives notably as emulsifiable concentrates (EC) intended to be diluted in water by the farmer, before application on a field.

Industry is searching for novel products with which products and methods, in which solvents, notably polar solvents are to be used, may be varied or optimized. Industry notably needs compounds with moderate cost, having interesting properties of use. Industry also needs compounds having a toxicological and/or ecological profile perceived as favorable, notably low volatility (low VOC), good biodegradability, low toxicity and/or low dangerousness.

The use of dialkylamides as solvents is known. This is a product of formula R—CONMe₂ wherein R is a hydrocarbon group such as an alkyl, typically a C₆-C₃₀ alkyl. Such products are notably marketed under the name of Genagen® by Clariant. These solvents find applications notably in the phytosanitary field.

Diesters of dicarboxylic acids are also known as solvents, notably diesters obtained by esterification of a mixture of adipic acid, glutaric acid and succinic acid. Such products are notably marketed under the names of Rhodiasolve® RPDE and Rhodiasolve® DIB by Rhodia.

Documents U.S. Pat. No. 3,288,794 and U.S. Pat. No. 3,417,114 describe diamide compounds of linear carboxylic acids of formula HOOC—(CH₂)_{z}—COOH such as adipic acid (z=4), glutaric acid (z=3), succinic acid (z=2). These compounds are solids, the melting points are of the order of 80° C. Therefore, they cannot be used as solvents at more moderate temperatures notably at room temperature. Such melting temperatures moreover make their handling and their use difficult and would involve hot procedures.

Document EP 186950 describes bis(amides) of dicarboxylic acids, obtained from a monoamide, from CO and from an amine. This document in particular describes the preparation of the adipamide of formula H₂NOC—(CH₂)_{z}—CONH₂ wherein z=4. The document teaches the use of the compounds as monomers or intermediates intended for preparing polymers.

Document U.S. Pat. No. 4,588,833 describes the preparation of amides of substituted succinic acid. This document in particular describes the preparation of compounds of the XOC—CH₂—CHR⁶—CONEt₂ type wherein R⁶ is a methyl or ethyl. The products are prepared by putting crotonic acid dialkylamide or pent-3-enoic acid diethylamide in the presence of CO, an alcohol or an amine HX. The document teaches the use of the compounds as antioxidants, as stabilizers for plastics, or as intermediates of organic synthesis.

There remains a need, as explained above, for other products, liquids, which may notably be useful as solvents and which may facilitate the handling and uses without necessarily requiring hot procedures.

The invention meets this need by proposing a product comprising at least two diamide compounds selected from diamide compounds of the following formulae (Ia), (Ib) and (Ic):

R²R³NOC-A^{a}-CONR⁴R⁵ (Ia)

R²R³NOC-A^{b}-CONR⁴R⁵ (Ib)

R²R³NOC-A^{c}-CONR⁴R⁵ (Ic)

wherein:

R², R³, R⁴ and R⁵, either identical or different, are groups selected from saturated or unsaturated, linear or branched, optionally cyclic, optionally aromatic, optionally substituted hydrocarbon groups comprising an average number of carbon atoms ranging from 1 to 36, R² and R³ on the one hand and R⁴ and R⁵ on the other hand being optionally able to form together a ring, optionally substituted and/or optionally comprising a heteroatom, and

A^{a}, A^{b} and A^{c} are linear divalent alkyl groups, each comprising a different number of carbon atoms.

It was surprisingly found that mixtures or combinations might be liquids while the components are individually solid.

The invention also relates to a method for preparing the product of the invention.

The invention also relates to the use of the product of the invention in formulations. The invention also relates to a method for preparing formulations by adding the product of the invention. The invention also relates to formulations comprising the product of the invention. The formulations may notably be phytosanitary formulations.

The invention also relates to the use of the product of the invention as a solvent, plasticizer or coalescence agent.

### DEFINITIONS

In the present application, the term of solvent in a broad sense is meant to cover notably the functions of co-solvent, crystallization inhibitor, stripper. The term of solvent may notably designate a product which is liquid at the temperature of use, preferably with a melting point less than or equal to 20° C., preferably 5° C., preferably 0° C., which may contribute to liquefying a solid material, or preventing or delaying solidification or crystallization of matter in a liquid medium.

In the present application, a compound fitting a chemical formula designates any compound fitting the latter. It is mentioned that the term of “compound” also covers mixtures of several molecules fitting a same formula. This may therefore be a molecule of said formula, or a mixture of several molecules fitting said formula. For example a compound of formula (Ia) may be a molecule of formula (Ia) with defined R², R³, R⁴ and R⁵ groups, or a mixture of several molecules fitting the formula (Ia), said molecules having differences between them as regards the R², R³, R⁴ and R⁵ groups.

In the present application, by “composition of matter”, is meant a more or less complex composition comprising several chemical compounds. This may typically be a non-purified or moderately purified reaction product. The compound of the invention may notably be isolated and/or marketed and/or used in the form of a composition of matter comprising it. The product of the invention is a composition of matter. In the composition of matter, the whole of the compounds of formulae (Ia), (Ib) and (Ic) may account for at least 10% by weight. Preferably, the whole of these compounds form the main product of the material composition. By main product is meant in the present application, the product with the highest content, even if its content is less than 50% by weight (for example in a mixture of 40% A, 30% B and 30% C, the product A is the main product). Even more preferably in the composition of matter, the whole of the compounds of formulae (Ia), (Ib) and (Ic) account for at least 50% by weight of the composition of matter, for example from 70 to 95% by weight, and even from 75 to 90% by weight.

### Diamide Compounds

The product of the invention comprises at least two of the compounds of formulae (Ia), (Ib) and (Ic). It preferably comprises the three compounds.

In the formulae (Ia), (Ib) and (Ic), A^{a}, A^{b} and A^{c} are linear divalent alkyl groups each comprising a different number of carbon atoms. The groups A^{a}, A^{b}, and A^{c} correspond to diacids of formulae HOOC-A^{a}-COON, HOOC-A^{b}-COON, and HOOC-A^{c}-COON. The numbers of carbon atoms may be notably selected from 2 (corresponding acid=succinic acid), 3 (corresponding acid=glutaric acid), 4 (corresponding acid=adipic acid), 5, 6, 7, 8, 9, 10.

According to a particular embodiment:

A^{a} is the group of the following formula —CH₂—CH₂— (ethylene, corresponding acid=succinic acid)

A^{b} is the group of the following formula —CH₂—CH₂—CH₂—(n-propylene, corresponding acid=glutaric acid)

A^{c} is the group of the following formula —CH₂—CH₂—CH₂—CH₂— (n-butylene, corresponding acid=adipic acid).

The product preferably comprises the three diamide compounds with these particular groups A^{a}=ethylene, A^{b}=n-propylene and A^{c}=n-butylene.

According to an interesting embodiment, the proportions of the compounds of formulae (Ia), (Ib) and (Ic), relatively to the total number of moles of diamides of formulae (Ia), (Ib) and (Ic), are the following:

from 1 to 20%, preferably from 5 to 15%, by moles of diamide of formula (Ic)

from 45 to 75%, preferably from 55 to 65%, by moles of diamide of formula (Ib) and

from 15 to 45%, preferably from 20 to 33%, by moles of diamide of formula (Ia).

In the case when A^{a}=ethylene, A^{b}=n-propylene, and A^{c}=n-butylene, the mixture of these compounds in these proportions may correspond (in the amide version) to a mixture of adipic, glutaric and succinic (“AGS”) acids available in large amounts as a by-product of the preparation of adipic acid, a monomer used in the manufacturing of polyamide or polyurethane. The mixture of diacids or of diesters obtained from the mixtures of diacids may be a particularly interesting raw material from an economical, industrial and environmental point of view since a by-product is used and the use of resources is optimized.

The groups R², R³, R⁴ and R⁵, either identical or different, are groups selected from saturated or unsaturated, linear or branched, optionally cyclic, optionally aromatic, optionally substituted hydrocarbon groups comprising an average number of carbon atoms ranging from 1 to 36, R² and R³ on the one hand and R⁴ and R⁵ on the other hand may optionally form together a ring, optionally substituted and/or optionally comprising a heteroatom. The ring typically comprises the nitrogen atom to which R² and R³ or R⁴ and R⁵ are bound. The ring may comprise an additional heteroatom. The substituent may be a hydroxy group.

According to a particular embodiment, the pairs R² and R³ on the one hand and R⁴ and R⁵ on the other hand are identical pairs. According to a particular embodiment, R² and R³ are identical. According to a particular embodiment, R⁴ and R⁵ are identical. According to a particular embodiment, R², R³, R⁴ and R⁵ are identical.

The groups R², R³, R⁴, and R⁵, either identical or different may notably be selected from methyl, ethyl, propyl (n-propyl), isopropyl, nbutyl, isobutyl, n-pentyl, amyl, isoamyl, hexyl, cyclohexyl, hydroxyethyl groups. The groups R² and R³ may also be such that they form together with the nitrogen atom a morpholine, piperazine or piperidine group. According to particular embodiments, R²=R³=R⁴=R⁵=methyl, or R²=R³=R⁴=R⁵=ethyl or R²=R³=R⁴=R⁵=hydroxyethyl.

The product of the invention may notably be such that:

the compound of formula (Ia) is the compound Me₂NOC—CH₂—CH₂—CONMe₂ and

the compound of formula (Ib) is the compound Me₂NOC—CH₂—CH₂—CH₂—CONMe₂ and

the compound of formula (Ic) is the compound Me₂NOC—CH₂—CH₂—CH₂—CH₂—CONMe₂.

The product of the invention may notably be such that:

the compound of formula (Ia) is the compound Et₂NOC—CH₂—CH₂—CONEt₂

the compound of formula (Ib) is the compound Et₂NOC—CH₂—CH₂—CH₂—CONEt₂, and

the compound of formula (Ic) is the compound Et₂NOC—CH₂—CH₂—CH₂—CH₂—CONEt₂.

According to one embodiment, the product is different from the product consisting of

33% by weight or by moles of the compound (HOCH₂CH₂)HNOC—CH₂—CH₂—CONH(CH₂CH₂OH), and

67% by weight or by moles of the compound (HOCH₂CH₂)HNOC—CH₂—CH₂—CH₂—CONH(CH₂CH₂OH).

According to one embodiment, the product is different from the product consisting of

33% by weight or by moles of the compound (HOCH₂CH₂)(CH₃)NOC—CH₂—CH₂—CONH(CH₃)(CH₂CH₂OH), and

67% by weight or by moles of the compound (HOCH₂CH₂)(CH₃)NOC—CH₂—CH₂—CONH(CH₃)(CH₂CH₂OH).

According to one embodiment, the product is different from the product consisting of

33% by weight or by moles of the compound (HOCH₂CH₂)₂NOC—CH₂—CH₂—CON(CH₂CH₂OH)₂ and

67% by weight or by moles of the compound (HOCH₂CH₂)₂NOC—CH₂—CH₂—CH₂—CON(CH₂CH₂OH)₂.

According to one embodiment, the product is different from the product consisting of

20% by weight or by moles of the compound (HOCH₂CH₂)₂NOC—CH₂—CH₂—CON(CH₂CH₂OH)₂,

60% by weight or by moles of the compound (HOCH₂CH₂)₂NOC—CH₂—CH₂—CH₂—CON(CH₂CH₂OH)₂, and

20% by weight or by moles of the compound (HOCH₂CH₂)₂NOC—CH₂—CH₂—CH₂—CH₂—CON(CH₂CH₂OH)₂.

According to one embodiment, the product is different from the product consisting of

75% by weight or by moles of the compound (HOCH₂CH₂)₂NOC—CH₂—CH₂—CH₂—CON(CH₂CH₂OH)₂

25% by weight or by moles of the compound(HOCH₂CH₂)₂NOC—CH₂—CH₂—CH₂—CH₂—CON(CH₂CH₂OH)₂.

It is mentioned that the product of the invention my comprise at least 10% by weight, preferably at least 50% by weight, preferably at least 75%, for example at least 95%, of the compounds of formulae (Ia), (Ib) and (Ic). At a high concentration, the product may be an ingredient or an aid for methods, intended to be associated with other ingredients or to be applied in the presence of other chemical compounds. At a low concentration, the product may be a composition or formulation comprising other ingredients.

It is mentioned that the compounds (Ia), (Ib) and (Ic) may be separately introduced into the product. However, it is preferred to introduce them as a mixture or premix. According to a preferential embodiment, the product stems from a reaction mixture wherein the compounds (Ia), (Ib) and (Ic) are present. The product may notably be an amidification or trans-amidification product.

The product of the invention advantageously has a melting temperature of less than or equal to 35° C., preferably or less than or equal to 25° C., preferably less than or equal to 10° C., preferably less than or equal to 0° C.

### Method

The product of the invention may be prepared by any suitable method. Applying amidification or trans-amidification reactions on diacids or similar diesters, preferably in similar mixtures, will notably be preferred. Such reactions are known to one skilled in the art.

Thus, a suitable method for preparing a product of the invention may be a method comprising an amidification or trans-amidification step by a compound of formula R²R³NH and/or HNR⁴R⁵ from a mixture of at least two compounds, preferably the three compounds, selected from the compounds of the following formulae (I′a), (I′b) and (I′c):

R⁸OOC-A^{a}-COOR (I′a)

R⁸OOC-A^{b}-COOR (I′b)

R⁸OOC-A_{c}-COOR (I′c)

wherein R⁸ is a hydrogen atom or a C₁-C₆ alkyl, preferably methyl.

The compounds of formulae (I′a), (I′b), and (I′c) are considered as analogous diacids or diesters of the diamide compounds respectively.

The amidification or transamidification reaction may be conducted continuously, semi-continuously, or batchwise. In order to improve the conversion rate of the reaction (rate of conversion of the acid or of the diester) and/or decrease the amount of unreacted product in a composition of matter and/or improve productivity, reaction by-products may notably be removed during the latter reaction. Alcohols formed during the transamidification reaction may for example be removed by evaporation (stripping). It is noted that a very large excess of amine, an amine salt or any other means known to one skilled in the art may be used, for example as described in the text book “March's Advanced Organic Chemistry” of Michael B. Smith and Jerry March, 5^{th} Edition, John Wiley & Sons, pages 506-511.

The reaction may be followed by filtration and/or purification steps for example by distillation.

It is noted that the amidification or transamidification reaction may transit through activated intermediates such as acid chlorides obtained for example from the compounds of formulae (I′a), (I′b), (I′c) by reaction with thionyl chloride. The separation of hydrochloric acid, a by-product during this amidification reaction, from the reaction medium by any suitable means (formation of a salt, distillation), is an engine for displacing the reaction equilibrium towards the formation of the sought amide.

Diacids or diesters as mixtures may notably be mixtures of diacids stemming from the manufacturing of adipic acid (a so-called AGS mixture) or from diesters obtained from these mixtures of diacids. Mixtures of diesters are notably marketed under the name of Rhodiasolv® RPDE.

### Uses—Formulations

The product of the invention may notably be used as a solvent, co-solvent and/or crystallization inhibitor, as a plasticizer or as a coalescence agent.

By co-solvent is meant that other solvents may be associated with it. The use as a solvent or co-solvent notably comprises the use for dissolving a compound in a formulation, in a reaction medium, the use for totally or partly solubilizing a product to be removed (degreasing, stripping) and/or for facilitating detachment of films from materials.

The product of the invention may notably be used, for the functions indicated above or for other functions, in a phytosanitary formulation, in a cleaning formulation, in a stripping formulation, in a degreasing formulation, in a formulation of lubricants or textiles, in a coating formulation for example in a paint formulation, in a formulation of pigments or ink, in a plastic formulation.

The product may for example be used as coalescence agent in an aqueous paint formulation.

The product may notably be used as a solvent of resins for example in the cable cladding industry or in the electronics industry, notably as a solvent of PDVF.

The product may notably be used as a cleaning and/or stripping solvent in the electronics industry. It may notably be used in lithium batteries. It may notably be used on photo-resist resins, polymers, waxes, greases, oils.

The product may notably be used for cleaning inks, for example upon producing inks or during the use of ink in printing.

The product may notably be used for cleaning sieves or other tools applied in methods for making and/or recycling paper.

The product may notably be used for cleaning bitumens or tar sands, for example on coated substrates, on tools used for applying these materials, on dirtied clothes, on dirtied vehicles.

The product may notably be used for cleaning flying machines such as aircraft, helicopters, space shuttles.

The product may notably be used as a degreasing agent on metal surfaces, for example surfaces of tools, of manufactured objects, of metal sheets, of molds, notably in steel or in aluminium or in alloys of these metals.

The product may notably be used as a cleaning solvent on hard surfaces or textile surfaces.

The product may notably be used as a solvent for stripping paint or resins, on tool surfaces, for example on foundry molds, on surfaces of industrial sites (floors, partitions etc. . . . ). The formulations for stripping paints may notably be formulations based on water (the compound being mixed with water) or based on a solvent (the compound then being the solvent or a compound mixed with water).

The product may notably be used as a plasticizer in formulations of thermoplastic polymers.

The cleaning and/or degreasing formulations may notably be formulations for housekeeping, performed in households or in public domains (hotels, offices, factories . . . ). These may be formulations for cleaning hard surfaces such as floors, furniture and fittings' surfaces of kitchens and bathrooms, dishes. These formulations may also be used in the industrial sphere for degreasing manufactured products and/or for cleaning them. Such formulations may notably be for cleaning and/or stripping products, tools, molds, clothes or other objects.

The product of the invention my notably be used in phytosanitary formulations comprising a solid active product. More details are given below where the term of “solvent” may designate the product of the invention.

It is mentioned that it is possible to associate with the product, or introduce into the product solvents or co-solvents or other crystallization inhibitors, by solvents of the family of phosphates, phosphonates or phosphine oxides such as TEBP, TBP, TEPO, DBBP. Mention is also made of alkyl dimethyl amides wherein the alkyl is a C₆-C₁₈ alkyl, notably those marketed under the Genagen brand. Mention is also made of ester lactates, notably those marketed under the Purasolv brand. Mention is also made of fatty acid methyl esters, notably those marketed under the Phytorobe brand. Mention is also made of diacid diesters (dibasic esters), notably those marketed by Rhodia under the brands of Rhodiasolv RPDE, and Rhodiasolv DIB. Mention is also made of hydrocarbon cuts, cyclic amides such as NMP, lactones. Mention is also made of bis(dialkylamides) which are the object of document WO 2008//074837.

Detailed Use within the Scope of Phytosanitary Formulations

The phytosanitary formulation is generally a concentrated phytosanitary formulation comprising an active compound.

Agriculture uses many active materials such as fertilizers or pesticides, for example insecticides, herbicides or fungicides. They are referred to as active phytosanitary products (or of active material). Active phytosanitary products are generally produced in pure form or highly concentrated. They should be used in farms at low concentrations. For this purpose, they are generally formulated with other ingredients in order to facilitate weight dilution by the farmer. They are referred to as phytosanitary formulations. The dilution performed by the farmer is generally carried out by mixing the phytosanitary formulation with water.

Thus phytosanitary formulations should facilitate weight dilution by the farmer in order to obtain a product in which the phytosanitary product is properly dispersed, for example as a solution, an emulsion, a suspension or a suspo-emulsion. Phytosanitary formulations thereby allow transport of a phytosanitary product in relatively concentrated form, easy packaging and/or easy handling for the final user. Different types of phytosanitary formulations may be used depending on the different phytosanitary products. Mention is for example made of emulsifiable concentrates (EC), concentrated emulsions (emulsion in water EW), micro-emulsions (ME), wettable powders (WP), water-dispersible granules (WDG). Formulations which may be used depend on the physical form of the phytosanitary product (for example a solid or a liquid), and on its physico-chemical properties in the presence of other compounds such as water or solvents.

After weight dilution by the farmer, for example by mixing with water, the phytosanitary product may be found in different physical forms: solution, dispersion of solid particles, dispersion of droplets of the product, droplets of solvent in which the product is dissolved . . . . Phytosanitary formulations generally comprise compounds with which these physical forms may be obtained. These for example may be surfactants, solvents, mineral supports, and/or dispersants. Very often these compounds do not have an active nature but an intermediate nature as an aid for the formulation. Phytosanitary formulations may notably be in liquid form, or in solid form.

In order to prepare phytosanitary formulations of solid active phytosanitary products, it is known how to solubilize the product in a solvent. The phytosanitary formulation thus comprises a solution of the product in the solvent. The formulation may be in solid form, for example as a wettable powder (WP) wherein the solution impregnates an inorganic support, for example kaolin and/or silica. The formulation may alternatively be in liquid form, for example as an emulsifiable concentrate (EC) having a single limpid liquid phase comprising the solvent and the product in the solution, which may form an emulsion by addition of water, without stirring or with slight stirring. It may also be in the form of a cloudy concentrated emulsion (EW), the water-dispersed phase of which comprises the solvent and the product in solution in the solvent. It may also be in the form of a limpid micro-emulsion (ME), the water-dispersed phase of which comprises the solvent and the product in solution in the solvent.

Certain solid phytosanitary actives are often difficult to formulate. For example tebuconazole is a particularly effective fungicide and of widespread use for cultivating soya bean for example. For certain phytosanitary actives, it is difficult to produce stable easy-to-dilute concentrated formulations for the farmer and without any substantial drawbacks (either found or perceived) as regards security, toxicity and/or ecotoxicity. For certain actives, it is difficult to formulate them at relatively high concentrations with sufficient stability. In particular it is necessary to avoid the occurrence of crystals in particular at a low temperature and/or during dilution and/or during storage at a high temperature of the diluted composition. The crystals may have negative effects, notably clogging of the filters of the devices used for distributing the diluted composition, clogging of the spraying devices, reducing the overall activity of the formulation, generating unnecessary problems with waste treatment systems for eliminating the crystals, and/or causing a poor distribution of the active product over the agricultural plot.

The formulations comprising the solvent notably have:

solubilization of significant amounts of actives,

absence of crystallization, even with demanding conditions,

good biological activity which may be due to good solvation, and/or

a safety, toxicology and/or eco-toxicology profile perceived as favorable.

The phytosanitary formulation may further be a concentrated phytosanitary formulation comprising:

a) an active phytosanitary product,
b) the solvent (product of the invention)
c) optionally at least one emulsifying agent, preferably a surfactant, and
d) optionally water.

### Active Phytosanitary Product a)

Active phytosanitary products, notably solid products which are not water-soluble, are known to one skilled in the art. The active phytosanitary product may notably be a herbicide, an insecticide, an acaricide, a fungicide, or an agent for killing rodents (rodenticide) for example a raticide.

As non-limiting examples of suitable active materials, mention may be made of i.a. Ametryn, Diuron, Linuron, Chlortoluron, Isoproturon, Nicosulfuron, Metamitron, Diazinon, Aclonifen, Atrazine, Chlorothalonil, Bromoxynil, Bromoxynil heptanoate, Bromoxynil octanoate, Mancozeb, Maneb, Zineb, Phenmedipham, Propanyl, the phenoxyphenoxy series, the heteroaryloxyphenoxy series, CMPP, MCPA, 2,4-D, Simazine, the active products of the imidazolinone series, the family of organophosphorus compounds, with notably Azinphos-ethyl, Azinphos-methyl, Alachlor, Chlorpyriphos, Diclofop-methyl, Fenoxaprop-p-ethyl, Methoxychlor, Cypermethrin, Fenoxycarb, cymoxanil, chlorothalonyl, Ikes neonicotinoid insecticides, the family of triazole fungicides such as azaconazole, bromucanozaole, cyproconazole, difenoconazole, diniconazole, epoxyconazole, fenbuconazole, flusilazole, myclobutanyl, tebuconazole, triadimefon, triadimenol, strobilurins such as pyraclostrobin, picoxystrobin, azoxystrobin, famoxadone, kresoxym-methyl and trifloxystrobin, sulfonylureas such as bensulfuron-methyl, chloriumuron-ethyl, chlorsulfuron, metsulfuron-methyl, nicosulfuron, sulfomethuron-methyl, triasulfuron, tribenuron-methyl.

Water-insoluble products are selected from this list.

The following active phytosanitary products may notably be applied:

Alachlor, Chlorpyrifos, alpha-cypermethrin, Phenmedipham, Propanil, Pendimethalin, Triadimenol, Trifluralin, Oxyfluorfen, Dimethoate, Imidacloprid, Proxopur, Benomyl, Deltamethrin, Fenvalerate, Abamectin, Amicarbazone, Bifenthrin, Carbosulfan, Cyfluthrin, Difenconazole, Ethofenprox, Fenoxaprop-ethyl, Fipronil, Fenvalerate, Fluazifop-p-butyl, Flufenouron, Hexazinone, Lambda-cyalothrin, Methomyl, Permethrin, Prochloraz, Propiconazole, Tebuconazole.

These products and names are known to one skilled in the art. Several active phytosanitary products may be combined.

### Emulsifying Agent c)

The phytosanitary formulation may comprise an emulsifying agent, typically and preferably a surfactant. The emulsifying agents are agents intended to facilitate emulsification or dispersion after putting the formulation in the presence of water, and/or for stabilizing (over time and/or in temperature) the emulsion or the dispersion, for example, by avoiding sedimentation.

Surfactants are known compounds, which generally have a relatively low molar mass, for example of less than 1,000 g/mol. The surfactant may be an anionic surfactant in salified or acid form, a non-ionic preferably polyalkoxylated surfactant, a cationic surfactant, an amphoteric surfactant (a term also including zwitterionic surfactants). This may be a mixture or a combination of these surfactants.

As examples of anionic surfactants, mention may be made, without any intention to be limited thereto:

alkylsulfonic acids, arylsulfonic acids, optionally substituted with one or more hydrocarbon groups, and the acid function of which is partly or totally salified, such as C₈-C₅₀ alkylsulfonic acids, most particularly C₈-C₃₀, preferably C₁₀-C₂₂ alkylsulfonic acids, benzenesulfonic acids, naphthalenesulfonic acids, substituted with one to three C₁-C₃₀, preferably C₄-C₁₆ alkyl group and/or C₂-C₃₀, preferably C₄-C₁₆ alkenyl groups.

mono- or di-esters of alkylsulfosuccinic acids, including the linear or branched alkyl portion, optionally substituted with one or more hydroxyl and/or linear or branched C₂-C₄ alkoxyl groups (preferably ethoxylated, propoxylated, ethopropoxylated).
phosphate esters more particularly selected from those comprising at least one linear or branched, saturated, unsaturated or aromatic hydrocarbon group comprising 8 to 40, preferably 10 to 30 carbon atoms, optionally substituted with at least one (ethoxylated, propoxylated, ethopropoxylated) alcoxyl group. Further, they comprise at least one mono- or di-esterified phosphate ester group so that it is possible to have one or two, partly or totally salified, free acid groups. The preferred phosphate esters are of the type of mono- and di-esters of phosphoric acid and of alkoxylated (ethoxylated and/or propoxylated) mono-, di-, or tri-styrylphenol or of alkoxylated (ethoxylated and/or propoxylated) mono-, di- or tri-alkylphenol, optionally substituted with one to four alkyl groups; of phosphoric acid and of a C₈-C₃₀ preferably C₁₀-C₂₂ alkoxylated (ethoxylated or ethopropxylated) alcohol; of phosphoric acid and of a C₈-C₂₂, preferably C₁₀-C₂₂ non-alkoxylated alcohol.

sulfate esters obtained from saturated or aromatic alcohols optionally substituted with one or more alkoxylated (ethoxylated, propoxylated, ethopropoxylated) groups, and for which the sulfate functions appear in free acid form, or are partly or totally neutralized. As an example, mention may be made of the sulfate esters more particularly obtained from saturated or unsaturated C₈-C₂₀ alcohols, which may comprise 1 to 8 alkoxylated (ethoxylated, propoxylated, ethopropoxylated) units; the sulfate esters obtained from polyalkoxylated phenol, substituted with 1 to 3 saturated or unsaturated C₂-C₃₀ hydroxycarbon groups, and in which the number of alkoxylated units is comprised between 2 and 40; the sulfate esters obtained from polyalkoxylated mono-, di- or tri-styrylphenol in which the number of alkoxylated units varies from 2 to 40.

The anionic surfactants may be in acid form (they are potentially anionic) or in partly or totally salified form, with a counter-ion. The counter-ion may be an alkaline metal, such as sodium or potassium, an earth alkaline metal such as calcium, or further an ammonium ion of formula N(R)₄⁺ in which the R radicals, either identical or different, represent a hydrogen atom or a C₁-C₄ alkyl radical optionally substituted with an oxygen atom.

As examples of non-ionic surfactants, mention may be made, without any intention of being limited thereto:
polyalkoxylated (ethoxylated, propoxylated, ethopropoxylated) phenols substituted with at least one C₄-C₂₀, preferably C₄-C₁₂ alkyl radical, or substituted with at least one alkylaryl radical, the alkyl portion of which is a C₁-C₆ alkyl. More particularly the total number of alkoxylated units is comprised between 2 and 100. As an example, mention may be made of polyalkoxylated mono-, di- or tri-(phenylethyl)phenols, or polyalkoxylated nonylphenols. Among the ethoxylated and/or propoxylated, sulfated and/or phosphated di- or tri-styrylphenols, mention may be made of ethoxylated di-(phenyl-1-ethyl)phenol containing 10 oxyethylene units, ethoxylated di-(phenyl-1-ethyl)phenol, containing 7 oxyethylene units, sulfated ethoxylated di-(phenyl-1-ethyl)phenol, containing 7 oxyethylene units, ethoxylated tri-(phenyl-1-ethyl)phenol, containing 8 oxyethylene units, ethoxylated tri-(phenyl-1-ethyl)phenol, containing 16 oxyethylene units, sulfated ethoxylated tri-(phenyl-1-ethyl)phenol, containing 16 oxyethylene units, ethoxylated tri-(phenyl-1-ethyl)phenol, containing 20 oxyethylene units, phosphated ethoxylated tri-(phenyl-1-ethyl)phenol, containing 16 oxyethylene units.

polyalkoxylated (ethoxylated, propoxylated, ethopropoxylated) C₆-C₂₂ fatty alcohols or acids. The number of alkoxylated units is comprised between 1 and 60. The term of ethoxylated fatty acid includes both the products obtained by ethoxylation of a fatty acid by ethylene oxide and those obtained by esterification of a fatty acid by a polyethylene glycol.

polyalkoxylated (ethoxylated, propoxylated, ethopropoxylated) triglycerides of vegetable or animal origin. Thus, triglycerides stemming from lard, tallow, groundnut oil, butter oil, cotton seed oil, flax oil, olive oil, palm oil, grapeseed oil, fish oil, soya bean oil, castor oil, rapeseed oil, copra oil, coconut oil, and comprising a total number of alkoxylated units comprised between 1 and 60 are suitable. The term of ethoxylated triglyceride is both aimed at products obtained by ethoxylation of a triglyceride with ethylene oxide and those obtained by trans-esterification of a triglyceride with polyethylene glycol.

sorbitan esters, optionally polyalkoxylated (ethoxylated, propoxylated, ethopropoxylated), more particularly cyclized sorbitol esters of C₁₀-C₂₀ fatty acids such as lauric acid, stearic acid or oleic acid, and comprising a total number of alkoxylated units comprised between 2 and 50.

Useful emulsifiers are also notably the following products, all marketed by Rhodia:

Soprophor® TSP/724: a surfactant based on ethopropoxylated tri-styrylphenol.

Soprophor® 796/O: a surfactant based on ethopropoxylated tri-styrylphenol

Soprophor® CY 8: a surfactant based on ethoxylated tri-styrylphenol

Soprophor® BSU: a surfactant based on ethoxylated tri-styrylphenol

Alkamuls® RC: a surfactant based on ethoxylated castor oil

Alkamuls® OR/36: a surfactant based on ethoxylated castor oil

Alkamuls® T/20: a surfactant based on sorbitan ester

The formulation advantageously comprises at least 4%, preferably at least 5%, preferably at least 8%, by weight of dry material, of at least one surfactant c).

It is mentioned that the solvent may be associated with an aromatic and/or non-aromatic surfactant.

### Other Details as to the Phytosanitary Formulation

The concentrated phytosanitary formulation preferably does not comprise significant amounts of water. Typically, the water content is less than 50% by weight, advantageously less than 25% by weight. It will generally be less than 10% by weight.

The formulation preferably is a liquid formulation, for example in the form of an emulsifiable concentrate (EC), of a concentrated emulsion (EW) or a micro-emulsion (ME). In this case, it preferably comprises less than 500 g/L of water, more preferably less than 250 g/L. It will generally be less than 100 g/L.

The formulations may advantageously comprise:

a) from 4 to 60%, preferably from 10 to 50%, of the phytosanitary product, by weight of active material,
b) from 10 to 92%, preferably from 20 to 80%, of the solvent by weight,
c) from 4 to 60%, preferably from 5 to 50%, preferably from 8 to 25%, by weight of dry material, of an emulsifier, preferably a surfactant,
d) from 0 to 10% by weight of water.

Producing solid formulations is not excluded, for example formulations in which a liquid comprising the phytosanitary product solubilized in the solvent, is supported by a mineral and/or dispersed in a solid matrix.

The formulation may of course comprise other ingredients (or “additives”) other than the active phytosanitary product, the optional solvent(s), emulsifiers(s) and optional water. It may notably comprise agents for modifying viscosity, anti-foam agents, notably silicone anti-foam agents, sticking agents, anti-leaching agents, inert fillers, notably mineral fillers, anti-freeze agents.

Notably, the formulations may comprise additives, so-called other additives, which do not enter the definition of the products a), b), or c), such as:

other solvents, generally in a small amount, for example in an amount less than the amount of the product of the invention. As other solvents, mention may notably be made of the solvents from the family of phosphates, phosphonates or phosphine oxides such as TEBP. TBP, TEPO, DBBP. Mention is also made of alkyldimethylamides wherein the alkyl is a C₆-C₁₈ alkyl, notably those marketed under the Genagen brand. Mention is also made of ester lactates, notably those marketed under the Purasolv brand. Mention is also made of methyl esters of fatty acids, notably those marketed under the Phytorobe brand. Mention is also made of diesters of diacids (dibasic esters), notably those marketed by Rhodia under the brands of Rhodiasolv RPDE and Rhodiasolv DIB. Mention is also made of hydrocarbon cuts, cyclic amides such as NMP, lactones. Mention is also made of bis(dialkylamides) being the object of document WO 2008//074837.

crystallization inhibitors. These may be solvents mentioned above. These may also be non-polyalkoxylated fatty alcohols or fatty acids. Mention is for example made of the product Alkamuls® OL700 marketed by Rhodia.

Conventional methods for preparing phytosanitary formulations or mixtures of solvents may be applied. It is possible to operate by simply mixing the constituents.

The concentrated phytosanitary formulation is intended to be distributed over a cultivated field or intended to be cultivated, for example a soya bean field, most often after dilution in water in order to obtain a dilute composition. Dilution is generally performed by the farmer, directly in a tank (“tank mix”), for example in the tank of a device intended to spread out the composition. Addition of other phytosanitary products by the operator is not excluded, for example fungicides, herbicides, pesticides, insecticides, fertilizers. Thus, the formulation may be used for preparing a composition the active phytosanitary product, diluted in water, by mixing at least one part by weight of concentrated formulation with at least 10 parts of water, preferably less than a 1,000 parts. The dilution levels and the amounts to be applied on the field generally depend on the phytosanitary product and on the desirable dose for treating the field; this may be determined by the farmer.

Other details or advantages will become apparent upon considering the following examples without any limitation.

### EXAMPLES

Mixtures of diamides are prepared from diacid mixtures. For the preparation, the following general procedures are applied (in the formulae, A represents a mixture of A^{a}=ethylene, A^{b}=n-propylene, A^{c}=n-butylene).

### Procedure A: Formation of Acid Dichlorides (as a Mixture)

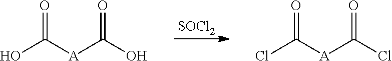

The mixture of diacids and of thionyl chloride are mixed at room temperature. The reaction mixture may be refluxed by heating for completing the reaction. The volatile species are removed by distillation under reduced pressure in order to obtain the raw product which is typically used as such without any other form of purification.

Procedure B: Formation of Diamide (as a Mixture) by Reaction with a Dialkylamine

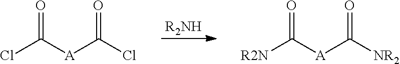

Toluene and triethylamine are loaded and cooled to −10° C. The dialkylamine is then loaded in liquid form. The acid dichloride (as a mixture), diluted in toluene is then added slowly while maintaining the temperature below +10° C. The mixture is then stirred for two hours at room temperature. The salts formed during the reaction are then filtered off and washed with ethyl acetate. The thereby obtained filtrate is then evaporated on the rotary evaporator in order to obtain the reaction raw product. The final product is finally obtained after distillation under reduced pressure.

### Example 1.1

### Preparation of a Product Comprising a Mixture of the Following Compounds

Me₂NOC—CH₂—CH₂—CONMe₂

Me₂NOC—CH₂—CH₂—CH₂—CONMe₂

Me₂NOC—CH₂—CH₂—CH₂—CH₂—CONMe₂

### Step 1

### Raw Materials

| Mixture of adipic acid, glutaric and | |
|---|---|
| succinic acid | Thionyl chloride |
| 500 g; 3.82 mol; | 1,127 mL; 15.30 mol; |
| Mw: average 132 | Mw: 118.97; 4 equiv. |

The acid dichloride (as a mixture) is obtained by Procedure A.
Raw product=631 g

### Step 2

### Raw Materials

| Acid dichloride | DMA | | |
|---|---|---|---|
| (as a mixture) | (dimethylamine) | TEA | Toluene |
| 609 g; 3.64 mol; | 404 mL; 8.96 mol; | 1,280 mL; | 2,000 + 1,000 mL |
| 1 equiv. | 1.23 equiv. | 9.11 mol; | |
| Mw: average 169 | Mw: 45.08 | 1.25 equiv. | |
| | | Mw: 101.2 | |

The dialkyl diamide (as a mixture) is obtained by Procedure B.
Raw product=729 g (brown liquid)
Final product=574 g (slightly yellow liquid)
GC analysis (surface area)>98% (sum of the isomers)
The obtained product is analyzed by gas chromatography. The analysis indicates (as a peak surface area):

| | |
|---|---|
| Me₂NOC—CH₂—CH₂—CONMe₂ | 13.49% |
| Me₂NOC—CH₂—CH₂—CH₂—CONMe₂ | 71.87% |
| Me₂NOC—CH₂—CH₂—CH₂—CH₂—CONMe₂ | 13.31% |

The product is observed at different temperatures. It is noticed that it is liquid at temperatures of 35° C., 30° C., 25° C., 20° C., 10° C. It is also noticed that it is free of crystals at these temperatures.

### Example 1.2

### Preparation of a Product Comprising a Mixture of the Following Compounds

Et₂-NOC—CH₂—CH₂—CONEt₂

Et₂-NOC—CH₂—CH₂—CH₂—CONEt₂

and

Et₂-NOC—CH₂—CH₂—CH₂—CH₂—CONEt₂

### Step 1

### Raw Materials

| Mixture of adipic acid, glutaric and | |
|---|---|
| succinic acid | Thionyl chloride |
| 500 g; 3.82 mol; Mw: average 132 | 1,127 mL; 15.30 mol; |
| | Mw: 118.97 4 equiv. |

The acid dichloride (as a mixture) is obtained by Procedure A.
Raw product=615 g

### Step 2

### Raw Materials

| Acid dichloride | DMA | | |
|---|---|---|---|
| (as a mixture) | (dimethylamine) | TEA | Toluene |
| 609 g: 3.64 mol; | 955 mL; 9.20 mol; | 1,292 mL; | 2000 + 1000 mL |
| 1 equiv. | 1.25 equiv. | 9.20 mol; | |
| Mw: average 169 | Mw: 73.14 | 1.25 equiv. | |
| | | Mw: 101.2 | |

The dialkyl diamide (as a mixture) is obtained by Procedure B.
Raw product=1068 g (brown liquid)
Final product=700 g (slightly yellow liquid)
GC analysis (surface area)>96% (sum of the isomers)
The obtained product is analyzed by gas chromatography. The analysis indicates (as peak surface area):

| | |
|---|---|
| Et₂—NOC—CH₂—CH₂—CONEt₂ | 13.09% |
| Et₂—NOC—CH₂—CH₂—CH₂—CONEt₂ | 70.60% |
| Et₂—NOC—CH₂—CH₂—CH₂—CH₂—CONEt₂ | 12.71% |

The product is observed at different temperatures. It is noticed that it is liquid at temperatures of 35° C., 30° C., 25° C., 20° C., 10° C., 0° C., −10° C. It is also noticed that it is free of crystals at these temperatures.

### Examples 2 to 4

### Uses as Solvents—Phytosanitary Formulations

By mixing the ingredients, formulations of various phytosanitary actives of the emulsifiable concentrate type (EC) are prepared.
The formulations comprise

the active in an amount by weight (of active material) indicated in the table below,

10% by weight of surfactant Alkamuls® RC, marketed by Rhodia

and as a solvent, the compound remainder of the Examples.

Examples 2 are comparative examples wherein the product Rhodiasolv® ADMA10 from Rhodia (Asia Pacific area) is used as a solvent: alkyl dimethylamide solvent.
The following tests are carried out:

Visual observation at 25° C., the aspect of the formulation is noted and the possible presence of crystals is located.

Visual observation at 0° C.—the formulation is placed for 7 days at 0° C. and the aspect of the formulation is noted and the possible presence of crystals is located (CIPAC MT39 test)

Visual observation at 0° C. with nucleation: A crystal of the active material is introduced into the formulation having spent 7 days at 0° C. for nucleation, and the formulation is again placed for 7 days at 0° C. The aspect of the formulation is noted and the possible presence of crystals is located.

| | | | | | Aspect |
|---|---|---|---|---|---|
| | | | | | at 05° C. |
| | | | Aspect | Aspect | with |
| Ex. | Solvent | Active | at 25° C. | at 0° C. | nucleation |
| 2.1C | Rhodiasolv ® | Alachlor -48% | Limpid | Crystals | Crystals |
| | ADMA 10 | | | | |
| 2.6C | Rhodiasolv ® | Pendimethalin - 33% | Limpid | Crystals | Crystals |
| | ADMA 10 | | | | |
| 2.8C | Rhodiasolv ® | Triadimenol - 23% | Limpid | Limpid | Crystals |
| | ADMA 10 | | | | |
| 2.10C | Rhodiasolv ® | Difenconazole - 25% | Limpid | Limpid | Crystals |
| | ADMA 10 | | | | |
| 2.11C | Rhodiasolv ® | Imidacloprid - 20% | Non-Soluble | Non-Soluble | Crystals |
| | ADMA 10 | | | | |
| 2.12C | Rhodiasolv ® | Dimethoate - 40% | Turbid | Turbid | Crystals |
| | ADMA 10 | | | | |
| 2.13C | Rhodiasolv ® | Oxyfluorfen - 22% | Limpid | Limpid | Crystals |
| | ADMA 10 | | | | |
| 2.14C | Rhodiasolv ® | Propoxur - 20% | Limpid | Limpid | Crystals |
| | ADMA 10 | | | | |
| 3.1 | Example 1.1 | Alachlor - 48% | Limpid | Limpid | Limpid |
| 3.2 | Example 1.1 | Chlorpyrifos - 40% | Limpid | Limpid | Limpid |
| 3.5 | Example 1.1 | Propanil - 36% | Limpid | Limpid | Limpid |
| 3.6 | Example 1.1 | Pendimethalin - 33% | Limpid | Limpid | Crystals |
| 3.11 | Example 1.1 | Imidacloprid - 20% | Limpid | Limpid | Limpid |
| 3.12 | Example 1.1 | Dimethoate - 40% | Limpid | Limpid | Crystals |
| 4.1 | Example 1.2 | Alachlor - 48% | Limpid | Limpid | Limpid |
| 4.2 | Example 1.2 | Clorpyrifos - 40% | Limpid | Limpid | Limpid |
| 4.3 | Example 1.2 | Alpha-Cypermethrin - 10% | Limpid | Limpid | Limpid |
| 4.5 | Example 1.2 | Propanil - 36% | Limpid | Limpid | Limpid |
| 4.7 | Example 1.2 | Tebuconazol - 23% | Limpid | Limpid | Limpid |
| 4.8 | Example 1.2 | Triadimenol - 23% | Limpid | Limpid | Limpid |
| 4.10 | Example 1.2 | Difenconazole - 25% | Limpid | Limpid | Limpid |
| 4.13 | Example 1.2 | Oxyfluorfen - 22% | Limpid | Limpid | Limpid |
| 4.14 | Example 1.2 | Propoxur - 20% | Limpid | Limpid | Limpid |

### Example 5

### Imidacloprid Formulation

The following EC formulation is prepared:

| | |
|---|---|
| Imidacloprid technical grade 98% | 204 g/L |
| Solvent of Example 1.1 | 856 g/L |
| Soprophor ® 769/P (surfactant, Rhodia) | 150 g/L |

The properties of the formulation are evaluated after the preparation:

Density at 20° C.: 1.120

pH (Cipoac MT75 Method) 3.8

Emulsification (Cipac test, at 0.5% concentration at 30° C., after 2 hours

| A | D | C |
|---|---|---|
| 0t | 0 | 0 |

Aspect at 0° C.: limpid solution

Aspect at 54° C.: limpid solution

The properties of the evaluation are formulated after 14 days at 54° C.:

pH (Cipoac MT75 Method): 3.0

Emulsification (Cipac test, at 0.5% concentration at 30° C., after 2 hours.

| A | D | C |
|---|---|---|
| 0t | 0 | 0 |

1-13. (canceled)

14. A product comprising at least two diamide compounds selected from two or more different classes Ia, Ib, and Ic, of diamide compounds of formulae:
R²R³NOC-A^{a}-CONR⁴R⁵ (Ia),
R²R³NOC-A^{b}-CONR⁴R⁵ (Ib),
and
R²R³NOC-A^{c}-CONR⁴R⁵ (Ic).
wherein:
R², R³, R⁴, and R⁵, which are identical or different, comprise saturated or unsaturated, linear or branched, optionally cyclic, optionally aromatic, hydrocarbon groups comprising an average number of carbon atoms ranging from 1 to 36.
R² and R³ optionally form a ring together with R⁴ and R⁵,
wherein said ring is optionally substituted and/or optionally comprises a heteroatom, and
A^{a}, A^{b}, and A^{c} represent linear divalent alkyl groups, each comprising a different number of carbon atoms.

15. The product of claim 14, wherein said product comprises at least one compound of class (Ia), at least one compound of class (Ib), and at least one compound of class (Ic).

16. The product of claim 14, wherein:
A^{a} comprises a —CH₂—CH₂-(ethylene) group,
A^{b} comprises a —CH₂—CH₂—CH₂-(n-propylene) group, and
A^{c} comprises a —CH₂—CH₂—CH₂—CH₂-(n-butylene) group.

17. The product of claim 14, wherein said product comprises, based on the total number of moles of diamides of formulae (Ia), (Ib), and (Ic):
1 to 20%, by moles of diamide of formula (Ic)
45 to 75%, by moles of diamide of formula (Ib), and
15 to 45%, by moles of diamide of formula (Ia).

18. The product of claim 14, wherein R², R³, R⁴, and R⁵, independently comprise a methyl, ethyl, propyl (n-propyl), isopropyl, n-butyl, isobutyl, n-pentyl, amyl, isoamyl, hexyl, cyclohexyl, hydroxyethyl, morpholine, piperazine or piperidine group.

19. The product of claim 14, wherein:
the compound of formula (Ia) comprises Me₂NOC—CH₂—CH₂—CONMe₂,
the compound of formula (Ib) comprises Me₂NOC—CH₂—CH₂—CH₂CONMe₂, and
the compound of formula (Ic) comprises Me₂NOC—CH₂—CH₂—CH₂—CH₂—CONMe₂.

20. The product of claim 14, wherein:
the compound of formula (Ia) comprises Et₂NOC—CH₂—CH₂—CONEt₂,
the compound of formula (Ib) comprises Et₂NOC-CM-CH₂—CH₂—CONEt₂, and
the compound for formula (Ic) comprises Et₂NOC—CH₂—CH₂—CH₂—CH₂—CONEt₂.

21. The product of claim 14, wherein said product comprises at least 10% by weight of the compounds of formulae (Ia), (Ib), and (Ic).

22. The product of claim 21, wherein said product comprises an amidification or trans-amidification product.

23. The product of claim 14, wherein said product has a melting temperature of less than or equal to 35° C.

24. A method for preparing a product,
wherein said product comprises:
at least two diamide compounds selected from two or more different classes Ia, Ib, and Ic, of diamide compounds of formulae:
R²R³NOC-A^{a}-CONR⁴R⁵ (Ia),
R²R³NOC-A^{b}-CONR⁴R⁵ (Ib),
and
R²R³NOC-A^{c}-CONR⁴R⁵ (Ic),
wherein:
R², R³, R⁴, and R⁵, which are identical or different, comprise saturated or unsaturated, linear or branched, optionally cyclic, optionally aromatic, hydrocarbon groups comprising an average number of carbon atoms ranging from 1 to 36.
R² and R³ optionally form a ring together with R⁴ and R⁵,
wherein said ring is optionally substituted and/or optionally comprises a heteroatom, and
A^{a}, A^{b}, and A^{c} represent linear divalent alkyl groups, each comprising a different number of carbon atoms;
said method comprising the step of:
amidification or trans-amidification with a compound of formula R²R³NH and/or HNR⁴R⁵ of a mixture of at least two compounds selected from two or more different classes I′a, I′b, and I′c of formula:
R⁸OOC-A^{a}-COOR⁸ (I′a)
R⁸OOC-A^{b}-COOR⁸ (I′b)
and
R⁸OOC-A^{c}-COOR⁸ (I′c),
wherein:
said at least two compounds are selected from classes (I′a), (I′b), and (I′c) to correspond, respectively, to said at least two diamide compounds, and
R⁸ comprises a hydrogen atom or a C₁-C₆ alkyl group.

25. A solvent comprising the product of claim 14.

26. A plasticizer comprising the product of claim 14.

27. A coalescence agent comprising the product of claim 14.

28. A phytosanitary formulation comprising the product of claim 14.

29. A cleaning formulation comprising the product of claim 14.

30. A stripping formulation comprising the product of claim 14.

31. A degreasing formulation comprising the product of claim 14.

32. A formulation of lubricants comprising the product of claim 14.

33. A coating formulation comprising the product of claim 14.

34. A formulation of pigments or ink comprising the product of claim 14.

35. A plastic formulation comprising the product of claim 14.
